(19) United States
(12) Patent Application Publication
(10) Pub. No.: US 2015/0145858 A1
(43) Pub. Date: May 28, 2015

(54) METHOD AND APPARATUS TO PROCESS CURRENT COMMAND USING PREVIOUS COMMAND INFORMATION

(71) Applicant: Samsung Electronics Co., Ltd., Suwon-si (KR)

(72) Inventors: Jeong-ae PARK, Seoul (KR); Kwon-taek KWON, Seoul (KR); Min-young SON, Hwaseong-si (KR)

(73) Assignee: SAMSUNG ELECTRONICS CO., LTD., Suwon-si (KR)

(21) Appl. No.: 14/287,325

(22) Filed: May 27, 2014

(30) Foreign Application Priority Data
Nov. 25, 2013 (KR) 10-2013-0143925

(51) Int. Cl. G06T 15/00; G06T 15/20; G06T 15/04

(52) U.S. Cl. CPC G06T 15/005; G06T 15/04; G06T 15/205
USPC 345/419; 345/522

(57) ABSTRACT

Provided is a method and apparatus for processing a current command by using previous command information. The rendering method includes receiving first data corresponding to a current command that is to be rendered, determining whether to reuse a second data corresponding to a previous command that has already been processed by comparing the first data with the second data, and processing the current command, at a renderer, based on a result of the determination.

### RELATED APPLICATIONS

This application claims the benefit under 35 USC 119(a) of Korean Patent Application No. 10-2013-0143925, filed on Nov. 25, 2013, in the Korean Intellectual Property Office, the entire disclosure of which is incorporated herein by reference for all purposes.

### BACKGROUND

1. Field

The following description relates to methods and apparatuses for processing a current command by using previous command information.

2. Description of Related Art

Three-dimensional (3D) graphics application program interface (API) standards include OpenGL, OpenGL ES, and Direct3D. API standards include methods of executing each command and displaying an image.

Rendering includes geometry processing and pixel processing. The geometry processing is a process of dividing objects included in a 3D space into a plurality of primitives, and the pixel processing is a process of determining colors of the primitives. When each command is executed, a large amount of computation is performed and a large amount of power is consumed. Accordingly, various methods for reducing the required amount of computational and the number of accesses to a memory when rendering is performed have been studied.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a rendering method including receiving first data corresponding to a current command that is to be rendered, determining whether to reuse a second data corresponding to a previous command that has already been processed by comparing the first data with the second data, and processing the current command, at a renderer, based on a result of the determination.

The determining of whether to reuse the second data may include determining to reuse the second data in response to a result of the comparison satisfying a first condition indicating that the current command and the previous command are identical to each other or a second condition indicating that the current command and the previous command are identical to each other except for a viewpoint, and determining to not reuse the second data in response to the result of the comparison not satisfying the first condition and the second condition.

The satisfying of the first condition may include determining whether all pieces of information included in the first data are identical to all pieces of information included in the second data.

The satisfying of the second condition may include determining whether pieces of information other than a transform parameter included in the first data are identical to pieces of information included in the second data.

The processing of the current command may include in response to the first condition being satisfied, generating at least one polygon based on a resolution of the previous command, and performing texturing on the at least one polygon using the second data.

The processing of the current command may include in response to the second condition being satisfied, generating at least one polygon based on a resolution of the previous command and an amount of image change between the previous command the current command, performing texturing on the at least one polygon using the second data, and performing geometry processing and pixel processing on an area of the current command that has not been textured.

The amount of the image change may include information indicating a change in a viewpoint between the previous command and the current command obtained by analyzing a transform parameter included in the first data and a transform parameter included in the second data.

The processing of the current command may include, performing geometry processing and pixel processing on the current command in response to the first condition and the second condition not being satisfied.

The satisfying of the first condition may include comparing a binding information of a draw command included in the current command with binding information of a draw command included in the previous command.

The first data may include at least one of vertex attribute data, index data, vertex shader binary, pixel shader binary, pixel shader binary, uniform data, texture data, or configuration data.

In another general aspect, there is provided a rendering apparatus including a receiver configured to receive first data corresponding to a current command that is to be rendered, a determiner configured to determine whether to reuse a second data corresponding to a previous command that has already been processed by comparing the first data with the second data, and a renderer configured to process the current command based on a result of the determination.

The determiner may be further configured: to reuse the second data in response to a result of the comparison satisfying a first condition indicating that the current command and the previous command are identical to each other or a second condition indicating that the current command and the previous command are identical to each other except for a viewpoint, and to not reuse the second data in response to the first condition and the second condition not being satisfied.

The first condition may include determining whether all pieces of information included in the first data are identical to all pieces of information included in the second data.

The second condition may include determining whether pieces of information other than a transform parameter included in the first data are identical to pieces of information included in the second data.

In response to the first condition being satisfied, the renderer may be further configured to: generate at least one polygon based on a resolution of the previous command, and perform texturing on the at least one polygon using the second data.

In response to the second condition being satisfied, the renderer may be further configured to: generate at least one polygon based on a resolution of the previous command and an amount of image change between the previous command and the current command, perform texturing on the at least one polygon using the second data, and perform geometry processing and pixel processing on an area of the current command that has not been textured.

The amount of the image change may include information indicating a change in a viewpoint between the previous command and the current command obtained by analyzing a transform parameter included in the first data and a transform parameter included in the second data.

In response to the first condition and the second condition not being satisfied, the renderer may be further configured to perform geometry processing and pixel processing on the current command.

Other features and aspects will be apparent from the following detailed description, the drawings, and the claims.

### BRIEF DESCRIPTION OF THE DRAWINGS

FIG. 1 is a diagram illustrating an example of a rendering process.

FIG. 2 is a diagram illustrating an example of a rendering apparatus.

FIG. 3 is a diagram illustrating an example of a rendering unit

FIGS. 4A through 4D are diagrams illustrating examples of images corresponding to a current command and a previous command.

FIG. 5 is a diagram illustrating an example of an operation of the rendering apparatus.

FIGS. 6A and 6B are diagrams illustrating examples of an operation of the rendering apparatus when a second condition is satisfied.

FIG. 7 is a diagram illustrating an example of a rendering method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

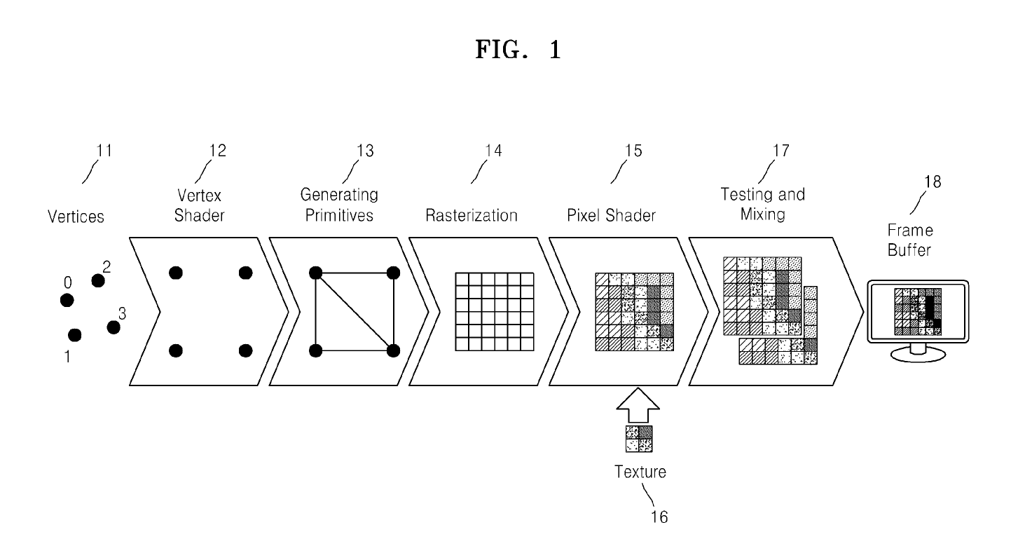

FIG. 1 is a diagram illustrating an example of a rendering process. The operations in FIG. 1 may be performed in the sequence and manner as shown, although the order of some operations may be changed or some of the operations omitted without departing from the spirit and scope of the illustrative examples described. Referring to FIG. 1, the process of processing a three-dimensional (3D) image, i.e., the rendering process, includes operations 11 through 17. Geometry processing is performed using operations 11 through 13 and pixel processing is performed using operations 14 through 17 are operations.

Operation 11 is an operation of generating vertices indicating an image. The vertices are generated in order to describe objects included in the image.

Operation 12 is an operation of shading the generated vertices. A vertex shader may perform shading on the vertices by assigning colors to the vertices generated in the operation 11.

Operation 13 is an operation of generating primitives. The term ‘primitive’ refers to a polygon that is formed of points, lines, or vertices. For example, the primitives may be triangles formed by connecting three vertices.

Operation 14 is an operation of rasterizing a primitive. When the primitive is rasterized, the primitive is divided into a plurality of fragments. The term ‘fragment’ refers to a portion of a primitive and may be a basic unit for performing image processing. A primitive includes only information about vertices. Accordingly, interpolation is performed when fragments between vertices are generated during rasterization.

Operation 15 is an operation of shading pixels. Although shading is performed in units of pixels, shading may be performed in units of fragments. For example, when pixels or fragments are shaded, colors of the pixels or the fragments are assigned to the pixels or the fragments.

Operation 16 is an operation of texturing the pixels or the fragments. Texturing is a method using a previously generated image to designate a color of a pixel or a fragment. For example, when a color is designated to a fragment, shading is performed through computation whereas texturing is a method of assigning the same color as a color of an image, which has been previously generated to a fragment corresponding to the image.

In the operation 15 or 16, a large computational amount is required to shade or texture each pixel or fragment. Accordingly, it is advantageous to reduce a computational amount by more efficiently performing shading or texturing. Examples of methods of reducing a computational amount during shading include, but are not limited to, Z-test (or a depth test) and hidden surface removal (HSR). HSR is a method that does not perform shading on a first object covered by a second object that is disposed in front of the first object.

Operation 17 is an operation of performing testing and mixing.

Operation 18 is an operation of displaying an image that is stored in a frame buffer. An image corresponding to a command is generated through the operations 11 through 17, and information indicating the generated image is stored in the frame buffer. The image that is stored in the frame buffer is displayed on a display device.

A rendering apparatus generates (renders) an image corresponding to a command through the operations 11 through 18. Accordingly, to generate images corresponding to a plurality of commands, the rendering apparatus independently performs the operations 11 through 18 for each command.

Assuming that an image varies as time passes, there may be cases where an image corresponding to a command that has already been processed and an image corresponding to a command that is to be processed are identical or similar to each other. In other words, there may be cases where pieces of information included in two continuous frames may be identical or similar to each other.

Accordingly, a rendering apparatus may reduce the computational required during rendering by re-using a result obtained from a previous command that was processed (i.e., data corresponding to the previous command) to execute a current command.

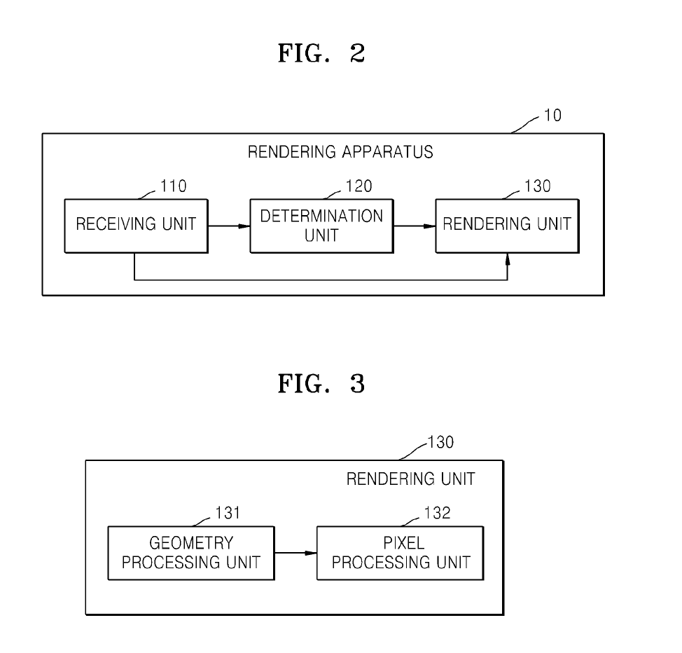

FIG. 2 is a diagram illustrating an example of a rendering apparatus 10. Referring to FIG. 2, the rendering apparatus 10 includes a receiving unit 110, a determination unit 120, and a rendering unit 130.

While components related to the present example are illustrated in the rendering apparatus 10 of FIG. 2, it is understood that those skilled in the art that may include other general-purpose components.

Also, each of the receiving unit 110, the determination unit 120, and the rendering unit 130 of the rendering apparatus 10 of FIG. 2 may be implemented using one or more general-purpose or special purpose computers, such as, for example, one or more processors, a controller and an arithmetic logic unit, a digital signal processor, a microcomputer, a field programmable array, a programmable logic unit, a microprocessor or any other device capable of responding to and executing instructions in a defined manner. Each processor may be realized as an array of logic gates, or a combination of a general-purpose microprocessor and a memory in which a program executable in the general-purpose microprocessor is stored. Also, it will be understood by one of ordinary skill in the art that the processor may be realized as other types of hardware.

The receiving unit 110 receives first data corresponding to a current command to be rendered. The current command refers to a command that is to be currently rendered by the rendering apparatus 10, and the first data includes vertex attribute data, index data, vertex shader binary, pixel shader binary, pixel shader binary, uniform data, texture data, or configuration data.

A command corresponding to an object to be rendered by the rendering apparatus 10 includes at least one draw command, and data that is used as an input during rendering is designated to each of the at least one draw command. The first data refers to data that is used as an input by a draw command corresponding to the current command.

The determination unit 120 compares the first data with second data corresponding to a previous command that has already been processed and determines whether to reuse the second data. As described above with reference to FIG. 1, a command that has already been processed is stored in a frame buffer. Accordingly, when a frame buffer corresponding to the previous command is used, it means that the second data is re-used when the current command is processed.

The previous command may refer to a command that is executed right before the current command is executed, or a command that is executed at an earlier time by the rendering apparatus 10. As described above, a command includes at least one draw command, and data that is used as an input during rendering for each of the at least one draw command. Accordingly, the second data includes the same type of data as that of the first data.

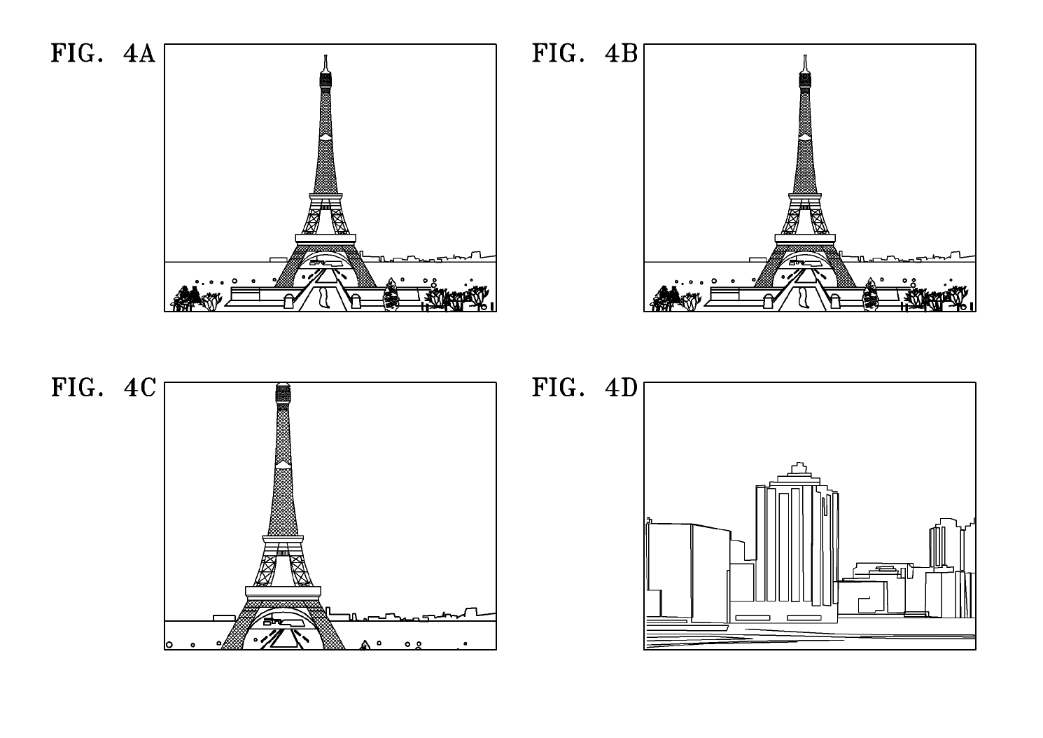

The rendering apparatus 10 executes each command. A rendering process performed by the rendering apparatus 10 is the same as that described above with reference to FIG. 1. Accordingly, before the rendering unit 130 processes the current command, the determination unit 120 may determine whether a result of the second data corresponding to the previous command is to be re-used when the current command is processed, thereby preventing the rendering apparatus 10 from performing the same computation. The determination unit 120 may determine whether the previous command and the current command are identical or similar to each other, thereby reducing the computational required to process the draw command and increasing an operating speed of the rendering apparatus 10. The previous command that is identical or similar to the current command will be further explained below with reference to FIG. 4.

FIG. 3 is a diagram illustrating an example of the rendering unit 130.

Referring to FIG. 3, the rendering unit 130 includes a geometry processing unit 131 and a pixel processing unit 132. While components related to the present example are illustrated in the rendering unit 130 of FIG. 3, it is understood that those skilled in the art may include other general-purpose components.

Each of the geometry processing unit 131 and the pixel processing unit 132 of the rendering unit 130 of FIG. 3 may be implemented using one or more general-purpose or special purpose computers, such as, for example, one or more processors, a controller and an arithmetic logic unit, a digital signal processor, a microcomputer, a field programmable array, a programmable logic unit, a microprocessor or any other device capable of responding to and executing instructions in a defined manner. Each processor may be realized as an array of logic gates, or a combination of a general-purpose microprocessor and a memory in which a program executable in the general-purpose microprocessor is stored. Also, it will be understood by one of ordinary skill in the art that the processor may be realized as other types of hardware.

The geometry processing unit 131 receives a draw command corresponding to a current command, and performs geometry processing on the received draw command. The geometry processing unit 131 generates a primitive list after performing the geometry processing on the draw command.

When the received draw command is identical to a draw command corresponding to a previous command that has already been processed, the geometry processing unit 131 does not need to repeat the same computation. Accordingly, the geometry processing unit 131 performs geometry processing on the draw command corresponding to the current command when the geometry processing unit 131 receives information from the determination unit 120, which indicates that the second data does not correspond to a previous command. When the geometry processing unit 131 receives information from the determination unit 120 indicating that the second data is re-used, the geometry processing unit 131 generates at least one polygon. The at least one polygon may be generated based on a resolution of the previous command, or the resolution of the previous command and an amount of image change.

The pixel processing unit 132 performs pixel processing on the current command by using primitive lists that are stored in a scene buffer. For example, when the rendering apparatus 10 is an apparatus that performs tile-based rendering, the pixel processing unit 132 renders all tiles that are included in the current command, and generates a final image by using the rendered tiles.

In this case, when the pixel processing unit 132 receives information indicating that the second data is re-used from the determination unit 120, the pixel processing unit 132 performs texturing on the polygon that is generated by the geometry processing unit 131 by using data that is stored in a previous frame buffer.

FIGS. 4A through 4D are diagrams illustrating examples of images corresponding to a current command and a previous command.

FIG. 4A is an image corresponding to the current command that is to be currently processed by the rendering unit 130, and FIGS. 4B through 4D are images corresponding to the previous command that have already been processed by the rendering unit 130.

Assuming that a moving image is generated by combining at least two still images, an image corresponding to a previous command and an image corresponding to a current image may be identical or similar to each other. For example, the image corresponding to the current command (of FIG. 4A) may be identical to the image corresponding to the previous command as shown in FIG. 4B. In another example, the image corresponding to the current command (of FIG. 4A) may be identical to the image corresponding to the previous command except for a viewpoint as shown in FIG. 4C. In another example, the image corresponding to the current command (of FIG. 4A) may be different from the image corresponding to the previous command as shown in FIG. 4D.

As to the images that are identical to each other as shown in FIGS. 4A and 4B, all pieces of information included in the first data (data corresponding to the current command) and the second data (data corresponding to the previous command) may be identical. Also, as to the images that are identical to each other except for a viewpoint as shown in FIGS. 4A and 4C, pieces of information other than a transform parameter included in the first data and a transform parameter included in the second data may be identical to each other. As to the images that are completely different from each other as shown in FIGS. 4A and 4D, there may be no identical information included in the first data and the second data.

The determination unit 120 determines that the second data corresponding to the previous command is to be re-used to process the current command when the image corresponding to the previous command is that of FIG. 4B or 4C. The determination unit 120 may make the determination by comparing the first data with the second data.

Referring back to FIG. 2, the rendering unit 130 processes the current command based on a result of the determination. The rendering unit 130 processes the current command by re-using a result of the second data or processes the current command without re-using the second data, based on the result of the determination of the determination unit 120.

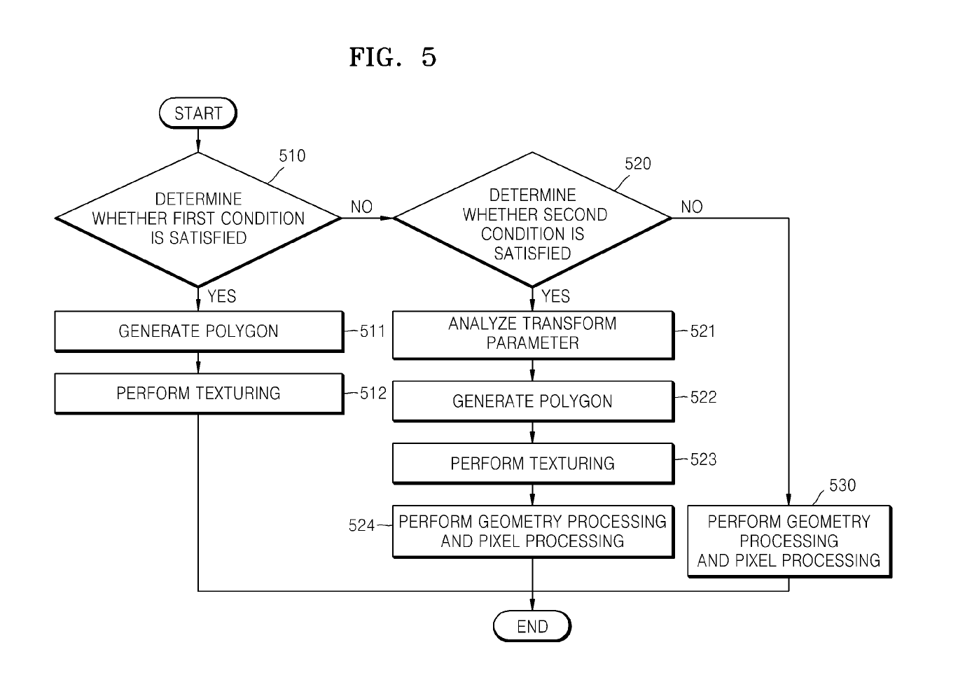

An operation of the rendering apparatus 10 will now be explained in detail with reference to FIG. 5. FIG. 5 is a diagram illustrating an example of an operation of the rendering apparatus 10. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. The above descriptions of FIGS. 1-4D, is also applicable to FIG. 5, and is incorporated herein by reference. Thus, the above description may not be repeated here.

In operation 510, the determination unit 120 compares first data with second data and determines whether a first condition is satisfied. The first condition indicates that a current command corresponding to the first data and a previous command corresponding to the second data are identical to each other. When the first condition is satisfied, the determination unit 120 determines that a result of the second data is to be re-used when the current command is processed.

For example, when all pieces of information included in the first data and all pieces of information included in the second data are identical to each other, the determination unit 120 determines that the first condition is satisfied. For example, the determination unit 120 may compare the second data with the first data stored in a frame buffer, and may determine whether the first condition is satisfied.

In another example, the determination unit 120 may compare the first data with the second data by determining whether there exists a draw command of the previous command that is identical to a draw command of the current command. In general, when the rendering apparatus 10 performs rendering, identical draw commands use identical input data. Accordingly, the determination unit 120 may determine that the first condition is satisfied when a draw command included the previous command and a draw command included in the current command are identical to each other. For example, the determination unit 120 may determine whether the first condition is satisfied by comparing binding information of a draw command included in the current command with binding information of a draw command included in the previous command.

When the determination unit 120 determines that the first condition is satisfied in operation 510, the operation proceeds to operation 511. When the determination unit 120 determines that the first condition is not satisfied, the operation proceeds to operation 520.

In operation 511, the rendering unit 130 generates at least one polygon based on a resolution of the previous draw command. The texture data for the polygon may be the texture data included in a previous frame buffer (the second data stored in a frame buffer).

For example, the geometry processing unit 131 may generate two polygons corresponding to the previous command. The polygons may be, but are not limited to, two triangles that divide a frame corresponding to the previous command.

In operation 512, the rendering unit 130 performs texturing on the at least one polygon that is generated by using the second data. The pixel processing unit 132 may perform pixel processing on the current command by texture-mapping the previous frame buffer (i.e., the second data stored in the frame buffer) to the generated polygon. The pixel processing unit 132 does not need to perform the same pixel processing on the current command.

In operation 520, the determination unit 120 determines whether a second condition is satisfied by comparing the first data with the second data. The second condition indicates that the current command corresponding to the first data and the previous command corresponding to the second data are identical to each other except for a viewpoint. When the second condition is satisfied, the determination unit 120 determines that the second data is to be re-used when the current command is processed.

For example, when only a transform parameter included in the first data and a transform parameter included in the second data are different from each other and other pieces of information of the first data and the second data are identical to each other, the determination unit 120 may determine that the second condition is satisfied. The transform parameter is included in uniform data. For example, when vertex attribute data, index data, vertex shader binary, pixel shader binary, texture data, and configuration data included in the first data and the second data are identical but uniform data included in the first data and the second data are different from each other, the determination unit 120 may determine that the second condition is satisfied.

When the determination unit 120 determines that the second condition is satisfied in operation 520, the operation proceeds to operation 521. When the determination unit 120 determines that the second condition is not satisfied in operation 520, the operation proceeds to operation 530.

In operation 521, the determination unit 120 analyzes the transform parameter included in the first data and the transform parameter included in the second data. The determination unit 120 may obtain an amount of image change by analyzing the transform parameter included in the first data and the transform parameter included in the second data. The amount of image change refers to information indicating a change in a viewpoint between the previous command and the current command.

Although the determination unit 120 analyzes the transform parameters, the illustrated examples are not limited thereto and the rendering unit 130 may analyze the transform parameters.

In operation 522, the rendering unit 130 generates at least one polygon based on a resolution of the previous command and an amount of image change between the previous command and the current command.

In operation 523, the rendering unit 130 performs texturing on the at least one polygon by using the second data.

In operation 524, the rendering unit 130 performs geometry processing and pixel processing on an area other than an area of the current command that has been textured.

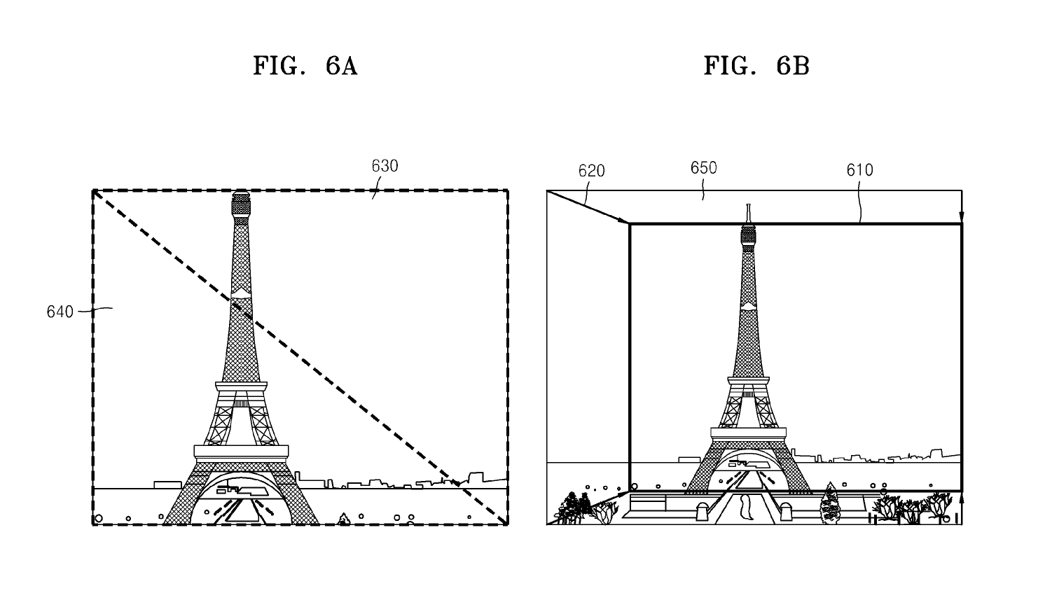

Operations 521 through 524 will now be explained in detail with reference to FIG. 6.

FIGS. 6A and 6B are diagrams illustrating examples of an operation of the rendering apparatus 10 when a second condition is satisfied. FIG. 6A is an image corresponding to the previous command, and FIG. 6B is an image corresponding to the current command. FIG. 6B, the image corresponding to the current command and FIG. 6A, the image corresponding to the previous command, are different from each other only in terms of a viewpoint, but objects included in the images are identical to each other.

When the second condition is satisfied, the determination unit 120 analyzes the transform parameter included in the first data and the transform parameter included in the second data. The determination unit 120 obtains an amount of image change between the previous command and the current command. Referring to FIGS. 6A and 6B, a viewpoint of the current command is set to be farther than a viewpoint of the previous command. Accordingly, the determination unit 120 may determine an area 610 of the image corresponding to the current command that is identical to the image corresponding to the previous command by analyzing the transform parameter included in the first data and the transform parameter included in the second data. Thus, the determination unit 120 may obtain an amount of change of the image 620.

In operation 522 of FIG. 5, the geometry processing unit 131 generates at least one polygon based on a resolution of the previous command and the amount of image change 620 between the previous command and the current command. The texture of the polygon is the texture data included in the previous frame buffer, i.e., the second data stored in the frame buffer. The at least one polygon may be, but is not limited to, two triangles 630 and 640 that divide a frame corresponding to the previous command.

Since the geometry processing unit 131 generates the at least one polygon based on the resolution of the previous command and the amount of image change 620 between the previous command and the current command, the pixel processing unit 132 may not need to perform the pixel processing on the area 610 of the current command that is identical to the previous command.

In operation 523 of FIG. 5, the pixel processing unit 132 performs pixel processing on the area 610 of the current command that is identical to the previous command by texture-mapping the previous frame buffer (that is, the second data stored in the frame buffer) to the generated polygon.

In operation 524 of FIG. 5, the rendering unit 130 performs geometry processing and pixel processing on an area 650 of the current command other than the area 610 that has been textured. Referring to FIG. 6B, the area 650 of a frame corresponding to the current command is not included in the frame corresponding to the previous command. Accordingly, even after operations 522 through 523 of FIG. 5 are performed, all areas of the current command may not be rendered.

The rendering unit 130 performs geometry processing and pixel processing for the area 650 of the current command other than the area 610 that has been textured. The rendering unit 130 does not need to perform geometry processing and pixel processing on the entire current command, thereby reducing a computational amount and increasing a processing speed of the rendering apparatus 10.

Referring to FIG. 5, in operation 530, the rendering unit 130 performs geometry processing and pixel processing on the current command. The determination unit 120 determines that the second data is not to be re-used when the first condition and the second condition are not satisfied. Accordingly, the rendering unit 130 performs geometry processing and pixel processing on the current command, as described above with reference to FIG. 1.

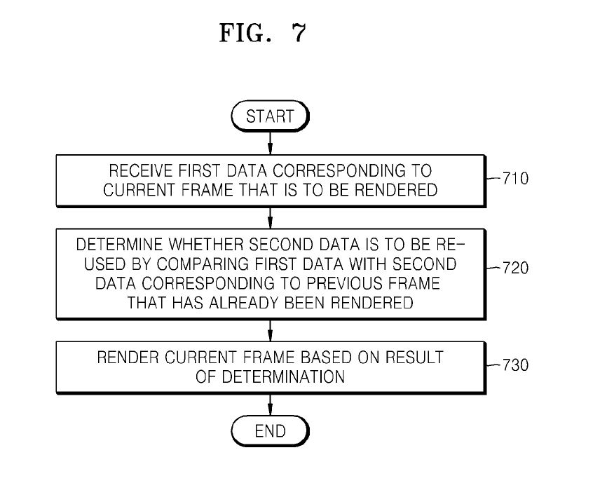

FIG. 7 is a diagram illustrating an example of a rendering method. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. The above descriptions of FIGS. 1-6, is also applicable to FIG. 7, and is incorporated herein by reference. Thus, the above description may not be repeated here.

In operation 710, the receiving unit 110 receives first data corresponding to a current command that is to be rendered. The current command refers to a command that is to be currently processed by the rendering apparatus 10. The first data refers to data that is used as an input by a draw command corresponding to the current command.

In operation 720, the determination unit 120 compares the first data with second data corresponding to a previous command that has already been processed and determines whether the second data is to be re-used. In other words, the determination unit 120 determines whether the second data corresponding to the previous command that has already been processed is to be re-used when the current command is processed.

In operation 730, the rendering unit 130 processes the current command based on a result of the determination. The rendering unit 130 processes the current command by re-using the second data or processes the current command without re-using the second data, based on the determination by the determination unit 120.

As described above, since a current command is executed by using a result obtained after a previous command is executed, a computational amount and power consumption of a graphics processing unit (GPU) during processing the current command may be reduced. Also, since whether the current command and the previous command are similar to each other is determined before the current command is executed and then the current command is executed based on a result of the determination, an operating speed of the GPU may be increased.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rendering method comprising:
receiving first data corresponding to a current command that is to be rendered;
determining whether to reuse a second data corresponding to a previous command that has already been processed by comparing the first data with the second data; and
processing the current command, at a renderer, based on a result of the determination.

2. The method of claim 1, wherein the determining of whether to reuse the second data comprises:
determining to reuse the second data in response to a result of the comparison satisfying a first condition indicating that the current command and the previous command are identical to each other or a second condition indicating that the current command and the previous command are identical to each other except for a viewpoint, and
determining to not reuse the second data in response to the result of the comparison not satisfying the first condition and the second condition.

3. The method of claim 2, wherein the satisfying of the first condition comprises determining whether all pieces of information included in the first data are identical to all pieces of information included in the second data.

4. The method of claim 2, wherein the satisfying of the second condition comprises determining whether pieces of information other than a transform parameter included in the first data are identical to pieces of information included in the second data.

5. The method of claim 2, wherein the processing of the current command comprises:
in response to the first condition being satisfied,
generating at least one polygon based on a resolution of the previous command; and
performing texturing on the at least one polygon using the second data.

6. The method of claim 2, wherein the processing of the current command comprises:
in response to the second condition being satisfied,
generating at least one polygon based on a resolution of the previous command and an amount of image change between the previous command the current command;
performing texturing on the at least one polygon using the second data; and
performing geometry processing and pixel processing on an area of the current command that has not been textured.

7. The method of claim 6, wherein the amount of the image change comprises information indicating a change in a viewpoint between the previous command and the current command obtained by analyzing a transform parameter included in the first data and a transform parameter included in the second data.

8. The method of claim 2, wherein the processing of the current command comprises, performing geometry processing and pixel processing on the current command in response to the first condition and the second condition not being satisfied.

9. The method of claim 2, wherein the satisfying of the first condition comprises comparing a binding information of a draw command included in the current command with binding information of a draw command included in the previous command.

10. The method of claim 1, wherein the first data comprises at least one of vertex attribute data, index data, vertex shader binary, pixel shader binary, pixel shader binary, uniform data, texture data, or configuration data.

11. A non-transitory computer-readable recording medium having embodied thereon a program for executing the method of claim 1.

12. A rendering apparatus comprising:
a receiver configured to receive first data corresponding to a current command that is to be rendered;
a determiner configured to determine whether to reuse a second data corresponding to a previous command that has already been processed by comparing the first data with the second data; and
a renderer configured to process the current command based on a result of the determination.

13. The rendering apparatus of claim 12, wherein the determiner is further configured:
to reuse the second data in response to a result of the comparison satisfying a first condition indicating that the current command and the previous command are identical to each other or a second condition indicating that the current command and the previous command are identical to each other except for a viewpoint, and
to not reuse the second data in response to the first condition and the second condition not being satisfied.

14. The rendering apparatus of claim 13, wherein the first condition comprises determining whether all pieces of information included in the first data are identical to all pieces of information included in the second data.

15. The rendering apparatus of claim 13, wherein the second condition comprises determining whether pieces of information other than a transform parameter included in the first data are identical to pieces of information included in the second data.

16. The rendering apparatus of claim 13, wherein in response to the first condition being satisfied, the renderer is further configured to:
generate at least one polygon based on a resolution of the previous command, and
perform texturing on the at least one polygon using the second data.

17. The rendering apparatus of claim 13, wherein in response to the second condition being satisfied, the renderer is further configured to:
generate at least one polygon based on a resolution of the previous command and an amount of image change between the previous command and the current command,
perform texturing on the at least one polygon using the second data, and
perform geometry processing and pixel processing on an area of the current command that has not been textured.

18. The rendering apparatus of claim 17, wherein the amount of the image change comprises information indicating a change in a viewpoint between the previous command and the current command obtained by analyzing a transform parameter included in the first data and a transform parameter included in the second data.

19. The rendering apparatus of claim 13, wherein in response to the first condition and the second condition not being satisfied, the renderer is further configured to perform geometry processing and pixel processing on the current command.
